(19) United States
(12) Patent Application Publication
(10) Pub. No.: US 2024/0395531 A1
(43) Pub. Date: Nov. 28, 2024

(54) MULTI-REFLECTION MASS SPECTROMETER

(71) Applicant: Thermo Fisher Scientific (Bremen) GmbH, Bremen (DE)

(72) Inventors: Dmitry Grinfeld, Bremen (DE); Hamish Stewart, Bremen (DE); Christian Hock, Bremen (DE)

(73) Assignee: Thermo Fisher Scientific (Bremen) GmbH, Bremen (DE)

(21) Appl. No.: 18/669,215

(22) Filed: May 20, 2024

(30) Foreign Application Priority Data
May 25, 2023 (GB) 2307867.8

(51) Int. Cl. H01J 49/40; H01J 49/06

(52) U.S. Cl. CPC H01J 49/406; H01J 49/06

(57) ABSTRACT

A multi-reflection time of flight mass spectrometer comprises two ion-optical mirrors elongated along a drift (Y) direction and separated in the Z direction and tilted so that their separation in the Z direction decreases with distance along the Y direction. Correction electrodes extend along the Y direction in or adjacent the space between the mirrors. Each correction electrode has a surface parallel to the Y-Z plane shaped such that its separation from one of the mirrors varies along the Y direction. The correction electrodes are biased to produce a combined voltage offset which varies as a function of distance along the Y direction. A first component corrects for an intended aberration arising from the mirror tilt and a second component to correct for unintended aberrations arising from perturbations to the ideal time of flight extending from maximum to minimum perturbations.

### CROSS REFERENCE TO RELATED APPLICATION

This application claims priority from application GB 2307867.8, filed May 25, 2023. The entire disclosure of application GB 2307867.8 is incorporated herein by reference.

### FIELD OF INVENTION

This invention relates to the field of mass spectrometry, in particular high mass resolution time-of-flight mass spectrometry and electrostatic trap mass spectrometry utilizing multi-reflection techniques for extending the ion flight path.

### BACKGROUND OF THE INVENTION

Various arrangements are known that utilise multi-reflections to extend the flight path of ions within mass spectrometers. Flight path extension is desirable to increase time-of-flight separation of ions within time-of-flight (ToF) mass spectrometers as it increases the ability to distinguish small mass differences between ions.

An example of a multi-reflection time-of-flight (MR-ToF) mass analyser is to be found in WO2013/110587. Two parallel opposing mirror electrodes are elongated in a drift direction (the Y direction). Ions are extracted from an ion trap and injected into the mirror electrodes and the ions are then reflected between the mirror electrodes (the Z direction) while also drifting relatively slowly along the extended length of the mirror electrodes in the drift direction. Hence, the ions follow a zigzag flight path through the mass analyser.

Furthermore, the mirror electrodes are tilted by an angle Θ such that their separation in the X direction decreases as they extend in the drift direction. Ions starting oscillations between the opposing mirror electrodes also drift in the Y direction due to the initial inclination at which the ions were injected into the mirror electrodes. The mirror convergence tilt angle Θ causes the trajectory inclination angle to decrease by 2Θ upon every oscillation which includes two reflections. As a result, the drift direction is eventually reversed such that the ions travel back through the mirror electrodes to be detected by an ion detector positioned adjacent the ion trap.

However, the tilted mirror electrodes cause ToF aberrations. This is because not all ions follow a common path through the mirror electrodes. The finite spread in the beam angle at which the ions are injected into the mirror electrodes results in some ions drifting further down the mirror electrodes than other ions. Ions entering at a shallow angle relative to the longitudinal axis through the mirror electrodes will drift further down the mirror electrodes than those injected at a relatively steep angle. Advantageously, the ions are spatially focused once more when they return to the ion detector. However, a temporal aberration is introduced because the period of oscillation of the ions decreases as a function of the distance along the drift direction as a result of the decreasing separation between the mirror electrodes.

These ToF aberrations are rectified by decelerating the ions as they cross between the mirror electrodes using stripe electrodes. The stripe electrodes are shaped to create an electric field with a voltage that changes as a function of the distance along the mirror electrodes. The electric field increases along the drift direction such that ions are decelerated more the further they drift along the mirror electrodes. This deceleration will cause the period of oscillation to increase as a function of the distance along the drift direction, thereby mitigating the decrease in period due to the converging mirror electrodes.

The voltage placed on the stripe electrodes can be adjusted to create an electric field that cancels the ToF aberrations resulting from the angular spread in the ions injected into the mirror electrodes. This correction assists in creating a substantially equal oscillation time on each oscillation of the ions between the opposing mirror electrodes at all locations along the drift length even though the distance between the mirrors changes.

These stripe electrodes are designed to compensate for the inevitable ToF aberrations caused even in perfect mirror electrodes by virtue of the required tilt.

An alternative MR-ToF analyser is described in US2020/0243322. The analyser comprises mirror electrodes that are parallel rather than tilted, and so ions progress along the length of the mirror electrodes with a constant drift velocity and are detected at the opposite end of the mirror electrodes to the ion trap from which they are injected. US2020/0243322 includes stripe electrodes, although for a different reason than WO2013/110587 as there is no need to correct ToF aberrations resulting from deliberately tilting the mirror electrodes. Instead, a first pair of curved stripe electrodes are used to correct for any curvature in the mirror electrodes. A second pair of stripe electrodes are used to correct for any misalignment between the mirror electrodes.

### SUMMARY

According to a first aspect, there is provided a multi-reflection time of flight mass spectrometer comprising two ion-optical mirrors, each mirror elongated generally along a drift direction away from the ion injection point (Y direction), each mirror opposing the other in an Z direction, the Z direction being orthogonal to the Y direction. The two mirrors are tilted such that the separation between the mirrors in the Z direction decreases as the distance along the Z direction increases.

The mass spectrometer also comprises at least two correction electrodes extending along at least a portion of the Y direction in or adjacent the space between the mirrors. Each correction electrode has a surface substantially parallel to the Y-Z plane and has a shape such that the surface is separated from one of the mirrors by a distance that varies along the Y direction. In use, the correction electrodes are electrically biased with voltages so as to produce, in at least a portion of the space extending between the opposing mirrors, a combined voltage offset which varies as a function of the distance along the Y direction. The voltages include a first component to correct for an intended aberration arising from the intended tilt angle of the mirrors and/or a second component to correct for unintended aberrations arising from a range of perturbations to the ideal time of flight extending from a maximum perturbation to a minimum perturbation (such as perturbations arising from mechanical imperfections in the mirrors), wherein the second component varies between a maximum value and a minimum value. The shapes of the at least two correction electrodes are chosen so that some or all the at least two correction electrodes may be biased with voltages including the first component and the second component, that varies between a maximum value and a minimum value, to generate a range of combined voltage offsets. These offsets correct for the range of time of flight aberrations corresponding to the intended aberration arising from the intended tilt angle of the mirrors and the unintended aberrations arising from the range of perturbations to the ideal time of flight extending from the maximum perturbation to the minimum perturbation.

The ideal time of flight of the ions through the mass spectrometer corresponds to the time of flight of ions through the mirrors when the mirrors are perfectly flat and in perfect alignment, set to the intended tilt angle. The correction electrodes provide correction both for the intended tilt angle between the mirrors via the first component, and also for errors in the actual configuration of the mirrors via the second component. For example, the mirrors may be misaligned and not at exactly the intended tilt angle. Also, the mirrors may not be perfectly straight and have a curvature due to sag (both caused by gravity and other factors such as release of stress within the mirrors and other machining imperfections).

The range of perturbations to the ideal time of flight may extend from a maximum perturbation due to a maximum positive misalignment error in the mirrors to a minimum perturbation due to a maximum negative misalignment error in the mirrors. The maximum positive and negative misalignment errors may be the maximum and minimum misalignment errors anticipated to affect the mass spectrometer. The maximum positive and negative misalignment errors may correspond to manufacturing tolerances. By way of example only, a shim may be used to introduce the intended tilt to an otherwise parallel mirror pair, in which case the maximum positive and negative misalignment errors may correspond to the manufacturing tolerance around the nominal thickness of the shim.

The correction electrodes may be shaped such that the combined voltage offset acts to shorten or lengthen the ions' average drift length through the mirrors in the +Y direction before they are reflected and drift back through the mirrors in the −Y direction. This arrangement allows smaller misalignment errors to be compensated. For larger misalignment errors, a greater combined voltage offset may be used that increases or decreases the number of oscillations the ions' make as they drift through the mirrors.

The range of perturbations to the ideal time of flight may extend from a maximum perturbation due to a maximum positive curvature error in the mirrors to a minimum perturbation due to a maximum negative curvature error in the mirrors. The maximum positive and negative curvature errors may be the maximum and minimum curvature errors anticipated to affect the mass spectrometer. The maximum positive and negative curvature errors in the mirrors may correspond to curvature in the mirrors due to sag.

At least one correction electrode may be shaped to compensate for both misalignment errors and curvature errors. Alternatively, the shape of an electrode of the at least two correction electrodes may correct for misalignment values independently of curvature values, and the shape of another electrode of the at least two correction electrodes may correct for curvature values independently of misalignment values.

Optionally, the at least two correction electrodes comprise one or more pairs of correction electrodes. The pair or each pair of correction electrodes may comprise a first correction electrode shaped such that when the first correction electrode is energised with a voltage having a value equal to the first component plus the maximum value of the second component, the first correction electrode generates a voltage offset that compensates for the intended aberration arising from the intended tilt angle of the mirrors and the unintended aberration arising from the maximum perturbation. The pair or each pair of correction electrodes may comprise a second correction electrode shaped such that when the second correction electrode is energised with a voltage having a value equal to the first component plus the minimum value of the second component, the second correction electrode generates a voltage offset that compensates for the intended aberration arising from the intended tilt angle of the mirrors and the unintended aberration arising from the minimum perturbation. The first and second correction electrodes may be shaped such that they produce different average drift lengths of ions through the mirrors. The physical lengths of the first and second correction electrodes may differ in the Y direction. When correction for the maximum perturbation is required, the first correction electrode is energised with a voltage having a value equal to the first component plus the maximum value of the second component, while the second correction electrode is grounded. When correction for the minimum perturbation is required, the second correction electrode is energised with a voltage having a value equal to the first component plus the minimum value of the second component, while the first correction electrode is grounded. When correction for a perturbation between the maximum and minimum perturbations is required, the first and second correction electrodes are energised with voltages equal to half the value of the first component plus the second component with a value between the predetermined minimum and maximum values. Each correction electrode then contributes half the required first component such that they sum to provide the correction for the tilt of the mirrors, and then are adjusted as required by the second component to correct for the unintended perturbation. If the mirrors are exactly as intended, correction for unintended aberrations is not required, and the first and second correction electrodes are energised with equal voltages having a value of half the first component plus the same value of the second component thereby cancelling the correction provided for maximum and minimum perturbations. The second component value may be zero. In such arrangements, each correction electrode compensates for both the intended time of flight aberration and the unintended time of flight aberrations, and so the shape of the correction electrodes must be a composite shape that reflects both functions.

Alternatively, different correction electrodes can be used to compensate for the intended time of flight aberration and the unintended time of flight aberrations. For example, the at least two correction electrodes may comprise an at least a first correction electrode having a shape to compensate for the intended time of flight aberration, and a second correction electrode having a shape corresponding to the difference between the shapes required such that, when energised with a voltage having a value equal to the first component plus the maximum value of the second component, the second correction electrode generates a voltage offset that compensates for the maximum perturbation and, when energised with a voltage having a value equal to the first component plus the minimum value of the second component, the second correction electrode generates a voltage offset that compensates for the minimum perturbation. If the mirrors are exactly as intended, correction for unintended aberrations is not required, and so the second correction electrode is grounded and the at least a first correction electrode is used to compensate for the intended aberration. When correction for unintended aberrations is required, the second electrode is energised with a voltage between the maximum and minimum values of the second component to provide the required correction: the maximum value will correct the maximum perturbation, the minimum value will correct the minimum perturbation, and values for the second component between the maximum and minimum values will correct perturbations between the maximum and minimum perturbations. The at least a first correction electrode may be a pair of electrodes sandwiching the second correction electrode. Each of the pair of electrodes may be energised with a voltage equal to half the first component.

According to a second aspect, there is provided a method of operating a multi-reflection time of flight mass spectrometer. The spectrometer comprises two ion-optical mirrors, each mirror elongated generally along a drift direction away from the ion injection point (Y direction), each mirror opposing the other in an Z direction, the Z direction being orthogonal to the Y direction. The two mirrors are tilted such that the separation between the mirrors in the Z direction decreases as the distance along the Y direction increases. The spectrometer also comprises at least two correction electrodes extending along at least a portion of the Y direction in or adjacent the space between the mirrors. Each correction electrode has a surface substantially parallel to the Y-Z plane and has a shape such that the surface is separated from one of the mirrors by a distance that varies along the Y direction. In use, the correction electrodes are electrically biased with voltages so as to produce, in at least a portion of the space extending between the opposing mirrors, a combined voltage offset which varies as a function of the distance along the Y direction, wherein the voltages include a first component to correct for an intended aberration arising from the intended tilt angle of the mirrors and a second component to correct for unintended aberrations arising from a range of perturbations to the ideal time of flight extending from a maximum perturbation to a minimum perturbation (such as aberrations caused by mechanical imperfections in the mirrors), wherein the second component varies between maximum and minimum values. The shapes of the at least two correction electrodes are chosen so that some or all the at least two correction electrodes may be energised with voltages having a value including the first component and the second component, that varies between a maximum value and a minimum value, to generate a combined voltage offset that compensates for the range of time of flight aberrations corresponding to the range of perturbations to the ideal time of flight extending from the maximum perturbation to the minimum perturbation.

The method comprises energising the mirrors to provide electric fields to cause ions to follow a zig zag path through the mirrors. The method also comprises energising each of the at least two correction electrodes with a voltage having the value that includes the first component and/or the second component such that the at least two correction electrodes generate a combined voltage offset that compensates for a time of flight aberration within a range of perturbations to the ideal time of flight extending from a maximum perturbation to a minimum perturbation. The method further comprises injecting ions from an ion source into the mirrors and detecting the ions with an ion detector located at the same end of the mirrors as the ion source.

Optionally, the at least two correction electrodes comprise one or more pairs of correction electrodes. Each pair of correction electrodes may comprise at least a first correction electrode shaped such that when the first correction electrode is energised with a voltage having a value equal to the first component plus the maximum value of the second component, the first correction electrode generates a voltage offset that compensates for the maximum perturbation. The one or more pairs of correction electrodes may further comprise a second correction electrode shaped such that when the second correction electrode is energised with a voltage having a value including the first component plus the minimum value of the second component, the second correction electrode generates a voltage offset that compensates for the minimum perturbation. The method may then comprises: (i) compensating for the maximum perturbation by energising the first electrode with a voltage with a value equal to the first component plus the maximum value of the second component, and not energising the second electrode; (ii) compensating for the minimum perturbation by energising the second electrode with a voltage having a value equal to the first component and the minimum value of the second component, and not energising the first electrode; or (iii) compensating for a perturbation between the maximum and minimum perturbations by energising the first electrode with a voltage with a value equal to half the first component and the second component with a value between the maximum and minimum values and energising the second electrode with a voltage with a value equal to half the first component plus the second component with a value between the maximum and minimum values.

Optionally, the at least two correction electrodes comprise at least a first correction electrode having a shape that, when energised with a voltage having a value equal to the first component, compensates for time of flight aberrations corresponding to the intended tilt angle of the mirrors along the Y direction. The at least two correction electrodes may further comprise a second correction electrode having a shape corresponding to the difference between the shapes required such that, when energised with a voltage having a value equal to the maximum value of the second component, the second correction electrode generates a voltage offset that compensates for the maximum perturbation and, when energised with a voltage having a value equal to the minimum value of the second component, the second correction electrode generates a voltage offset that compensates for the minimum perturbation. Then, the method may comprise: (i) compensating for the maximum perturbation by energising the at least a first correction electrode with a voltage equal to the first component to compensate for the intended time of flight aberration, and energising the second electrode with a voltage having the maximum value of the second component; (ii) compensating for the minimum perturbation by energising the at least a first correction electrode with a voltage equal to the first component to compensate for the intended time of flight aberration, and energising the second electrode with a voltage having the minimum value of the second component; or (iii) compensating for a perturbation between the maximum and minimum perturbations by energising the at least a first correction electrode with a voltage equal to the first component to compensate for the intended time of flight aberration, and energising the second electrode with a voltage with value between the maximum and minimum values of the second component. The at least a first correction electrode may be a pair of electrodes sandwiching the second correction electrode. Each of the pair of electrodes may be energised with a voltage equal to half the first component.

According to a third aspect, there is provided a method of designing a multi-reflection time of flight mass spectrometer. The method comprises configuring an ideal arrangement of an ion source, an ion detector and two ion-optical mirrors, each mirror elongated generally along a drift direction away from the ion injection point (Y direction), each mirror opposing the other in an Z direction, the Z direction being orthogonal to Y, such that ions provided from the ion source enter mirrors at the ion injection point and then follow a zig zag path through the mirrors when the mirrors are energised to provide electric fields. The method also comprises configuring at least two correction electrodes extending along at least a portion of the Y direction in or adjacent the space between the mirrors, wherein each correction electrode has a surface substantially parallel to the Y-Z plane and has a shape such that the surface is separated from one of the mirrors by a distance that varies along the Y direction and in which the correction electrodes are, in use, electrically biased with voltages so as to produce, in at least a portion of the space extending between the opposing mirrors, a combined voltage offset which varies as a function of the distance along the Y direction, wherein the voltages include a first component to correct for an intended aberration arising from the intended tilt angle of the mirrors and a second component to correct for unintended aberrations arising from a range of perturbations to the ideal time of flight extending from a maximum perturbation to a minimum perturbation (such as aberrations arising from mechanical imperfections in the mirrors), wherein the second component varies between maximum and minimum values. The method also comprises determining maximum and minimum perturbations away from the ideal arrangement of the mirrors, and the resulting maximum and minimum aberrations in time of flight of ions through the mirrors. The method also comprises determining the shape of the at least two correction electrodes such that some or all the at least two correction electrodes may be energised with voltages having values including the first component and the second component, that varies between a maximum value and a minimum value, to generate a range of combined voltage offsets that compensate for the range of time of flight aberrations extending from the maximum aberration to the minimum aberration.

The method may comprise determining the shapes of the at least two correction electrodes to compensate for a range of time of flight aberrations corresponding to a range of perturbations to the ideal time of flight extending from a maximum perturbation due to a maximum positive misalignment value in the mirrors to a minimum perturbation due to a maximum negative misalignment value in the mirrors.

The combined voltage offset may act to shorten or lengthen the ions' average drift length through the mirrors in the +Y direction before they are reflected and drift back through the mirrors in the −Y direction. The combined voltage offset may act to increase or decrease the number of oscillations the ions' make as they drift through the mirrors.

The method may comprise determining the shapes of the at least two correction electrodes to compensate for a range of time of flight aberrations corresponding to a range of perturbations to the ideal time of flight extending from a maximum perturbation due to a maximum positive curvature error in the mirrors to a minimum perturbation due to a maximum negative curvature error in the mirrors. The maximum positive and negative curvature errors in the mirrors correspond to curvature in the mirrors due to sag.

The method may comprise determining the shape of an electrode of the at least two correction electrodes to compensate for misalignment errors independently of curvature errors, and the shape of another electrode of the at least two correction electrodes to compensate for curvature errors independently of misalignment errors.

Optionally, the at least two correction electrodes comprise one or more pairs of correction electrodes. Then, the method may comprise for the one or more pairs of correction electrodes: determining the shape of a first correction electrode such that when the first correction electrode is energised with a voltage having a value equal to the first component plus the maximum value of the second component, the first correction electrode generates a voltage offset that compensates for the maximum perturbation. The method may also comprise determining the shape of a second correction electrode such that when the second correction electrode is energised with a voltage having a value equal to the first component plus the minimum value of the second component, the second correction electrode generates a voltage offset that compensates for the minimum perturbation. The first and second correction electrodes may be shaped such that they produce different average drift lengths of ions through the mirrors. The length of the first and second correction electrodes may differ in the Y direction.

Optionally, the method comprises determining the shape of at least a first correction electrode that, when energised with a voltage equal to the first component, compensates for time of flight aberrations corresponding to the intended tilt angle of the mirrors along the Y direction. The method may also comprise determining the shape of a second correction electrode to correspond to the difference between the shapes required such that, when energised with a voltage having the maximum value of the second component, the second correction electrode generates a voltage offset that compensates for the maximum perturbation and, when energised with a voltage having the minimum value of the second component, the second correction electrode generates a voltage offset that compensates for the minimum perturbation.

### LIST OF FIGURES

In order that the invention can be more readily understood, reference will now be made by way of example only, to the accompanying drawings in which:

FIG. 1 is a schematic representation of a prior art multi-reflection time-of-flight mass analyser;

FIG. 2 is a schematic representation of a mirror assembly design that provides a convergence angle via a shim;

FIG. 3A shows a normalised shape function for the correction electrodes;

FIG. 3B shows the resulting time of flight correction when the correction electrodes and the mirror tilt act together;

FIG. 4 is a schematic representation of first embodiment of a multi-reflection time-of-flight mass analyser having correction electrodes of unequal physical length;

FIG. 5A shows correction electrode shapes as a function of drift coordinate ‘y’ normalized to different drift lengths L1 and L2;

FIG. 5B shows an arrangement with two pairs of correction electrodes having different shapes, which have different electrical biases in order to provide variable effective drift lengths L between 300 mm and 400 mm and thus correct for the mirror misalignment;

FIG. 6A shows the shape function for a differential correction electrode whose shape function is equal to the difference between shape functions normalized to effective drift lengths of 375 mm and 325 mm, correspondingly;

FIG. 6B shows an arrangement with three pairs of correction electrodes including a pair of differential correction electrodes that are biased with a voltage U1;

FIG. 7A shows the shape function for correction electrode that implements the optimal solution for mirrors that have a sag, with the sag parameters ±0.01 mm;

FIG. 7B shows an arrangement with a pair of correction electrodes whose shape is deduced from the difference between the shapes in FIG. 7A and which are biased in order to correct for sag; and

FIG. 8 shows correction electrodes including pairs of differential correction electrodes that correct for both and curve.

### DETAILED DESCRIPTION

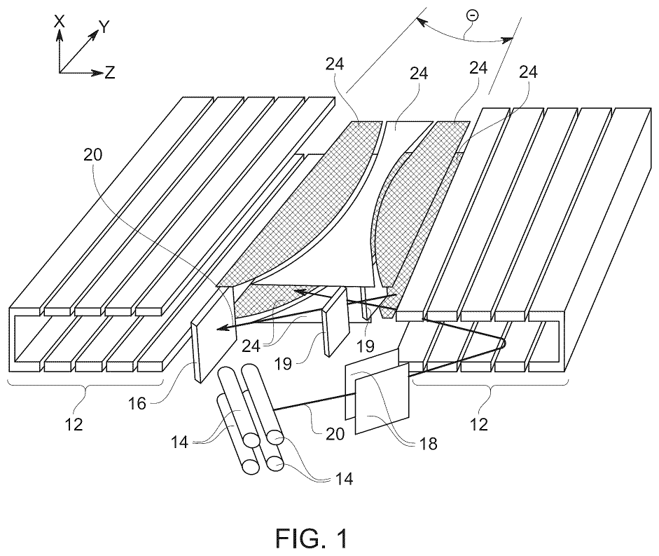

As discussed above, mass spectrometers commonly utilise multi-reflections to extend the flight path of ions which is desirable as it increases time-of-flight separation of ions and hence resolution within the time-of-flight (ToF) mass spectrometers. FIG. 1 shows an example of a multi-reflection time-of-flight (MR-ToF) mass analyser 10. A pair of ion-optical mirrors are provided by two parallel opposing mirror electrodes 12 that are elongated in a drift direction (the y direction). Ions 20 are extracted from an ion trap 14 and injected into the mirror electrodes 12. The ions 20 are beam-shaped by lenses/deflectors 18 before being reflected from the first mirror electrode 12. The expanding ion beam then meets a second deflector and drift focusing lens 19, which sets the final injection angle and collimates the ion beam 20 as best achievable. The ions 20 are then multiply reflected between the mirror electrodes 12 (the z direction) while also drifting relatively slowly along the extended length of the mirror electrodes 12 in the drift (y) direction. Hence, the ions 20 follow a zigzag flight path through the mass analyser 10.

Furthermore, the mirror electrodes 12 are tilted by an angle Θ (typically around 0.05 degrees) such that their separation in the z direction decreases as they extend in the drift direction. The convergence angle Θ causes the trajectory inclination angle of the ions 20 to decrease by 2Θ upon every oscillation (each oscillation includes two reflections). As a result, the drift of the ions 20 is eventually reversed such that the ions 20 travel back through the mirror electrodes 12 to be detected by an ion detector 16 positioned adjacent the ion trap 14.

The ions 20 have a small spread of injection angles and so the ion beam 20 widens as it drifts along the mirror electrodes 12. Hence, the drift length of an ion along the mirror electrodes 12 varies depending upon that ion's injection angle: those ions 20 injected at relatively steep angles have lower velocity components in the y direction and so will drift less far along the mirror electrodes 12 than those injected at relatively shallow angles that have higher velocity components in the y direction. The small tilt angle Θ acts to cause a spread in the time of flight of the ions 20 because ions 20 drifting further along the mirror electrodes 12 experience more of the narrowed gap between the mirror electrodes 12 than those ions 20 drifting less far. This causes differing times of flight for ions 20 having the same m/z ratio but with different injection angles, and hence a loss of resolution.

The error introduced by the tilted mirror electrodes 12 is addressed by adding a pair of correction electrodes 24 down the length of the drift dimension, with one correction electrode 24 located above the ion beam 20 and the other correction electrode 24 located below the ion beam 20. An edge of each correction electrode 24 has a shape determined by a shape function S(y) corresponding to the error to be corrected. The shape function may define the width of the correction electrode 24 (in the z-direction) as a function of position along the drift (y) direction. The correction electrodes 24 modify the electric field at a region where the ions 20 propagate and, therefore, cause additional drift deflection and time-of-flight perturbation to the ions 20. Moreover, the modification to the electric field can be set to counter the effect of the mirror electrodes' convergence, such that the correction electrodes 24 ensure that all ions 20 have the same the time of flight from the ion trap 14 to the ion detector 16 regardless of any variation of the starting point y₀ and the initial drift velocity v₀=dy₀/dt.

This correction can be achieved for varying values of the mirror electrodes' convergence angle Θ by adopting a certain shape of the correction electrodes 24. This shape may be defined by the shape function S(y) that is a polynomial describing the width of the correction electrode 24 in the z direction at each value y along the drift direction

$$S ( y ) = {c}_{0} + {k}_{0} s ( \frac{y}{L} ) \qquad ( 1 )$$

where y is the coordinate in the drift direction, and c₀ and k₀ are coefficients. k₀ is arbitrary as it is calibrated by the voltage applied to the correction electrodes 24. c₀ is also arbitrary and can be set with a certain degree of freedom. The required shaping of the correction electrode is described by a dimensionless the function s(y/L) whose argument is normalized to a mean drift length L (such that the function is dimensionless). The normalized function may be expressed in terms of a polynomial

$$s = {\sum }_{n = 1}^{5} c [ n ] \frac{{y}^{n}}{{L}^{n}}$$

where, for example, c[1]=0.78, c[2]=−7.54, c[3]=14.0, c[4]=−9.14, c[5]=2.1.

Optimising the coefficients c[n] gives the minimal dispersion in the time-of-flight of ions 20 with the same m/z ratio. The function s(y/l) may take negative values, but the shape function S(y) is kept positive by choosing c₀ which ensures that the stripe width S(y) is positive for all values of y.

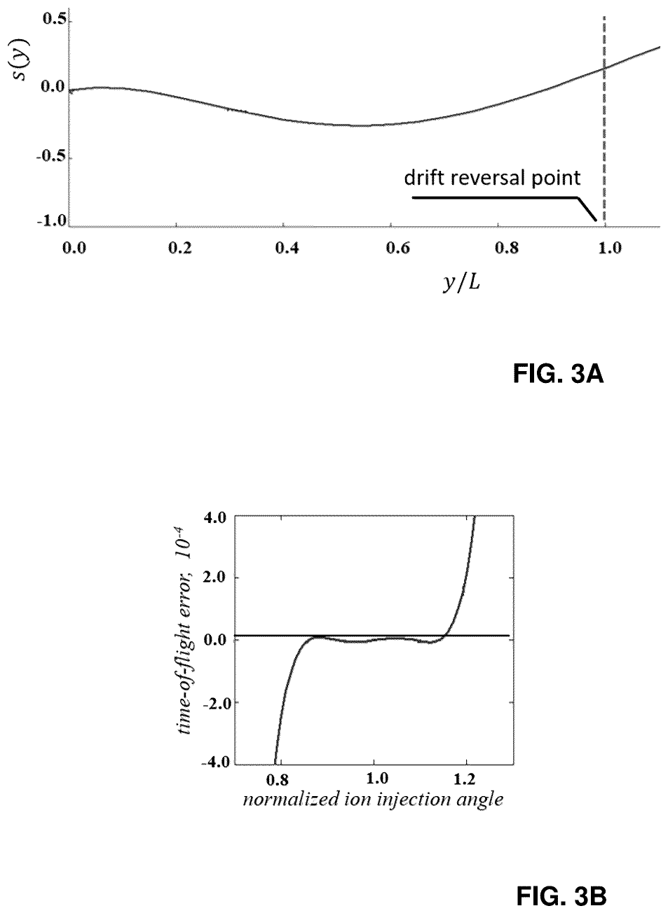

An example of the normalized function s(y) is shown in FIG. 3A. FIG. 3B shows the resulting time-of-flight error vs. the ion's injection angle and, in particular, the much reduced time-of-flight error plateau achieved within a 30% range of injection angles. This reduction in the time of flight dispersion minimizes the width of a detected ion peak caused by the thermal dispersion of initial ion velocities.

The ions' drift can be described in an adiabatic approximation by two pseudo-potentials Φₛ(y) and Φₘ(y) which arise from the correction electrodes 24 biased with a voltage Uₛ and the convergence angle Θ

$$\begin{matrix}{Φ}_{s} = {U}_{s} \frac{S ( y )}{W} , & {Φ}_{m} = \frac{2 {U}_{0}}{W} Θ y\end{matrix} \qquad ( 2 )$$

where W is the effective mean distance between the mirrors and U₀ is the ions' acceleration voltage (delivered by the ion trap 14). If an ion 20 is injected with an angle ϑ towards the positive direction of the z axis, its initial drift energy (per charge) is U₀ sin²ϑ and the ion's drift will be reversed at a position y=L where the sum of the pseudo-potentials is exactly equal to the initial drift energy, i.e. Φₛ(L)+Φₘ(L)=U₀ sin²ϑ.

To ensure the ions 20 are incident on the ion detector 16, the total drift time from y=0 to y=L and back to y=0 must be a multiple of the time per oscillation K₀T_{oscill} where K₀ is the number of oscillations (in the z direction) per drift (in the y direction). This requirement together with the requirement of correction of the time of flight error can be fulfilled with correction electrodes 24 shaped like that shown in FIG. 3A in the normalized coordinate y/L and when the mirror convergence angle Θ takes a specific value.

Though the dimensionless function s(y/L) is strictly defined for the optimal solution, the drift length L is a free parameter to be chosen. The drift length L is related to the mirror convergence angle Θ by the formula

$$Θ = 1.245 \times \frac{L}{{WK}_{0}^{2}} \qquad ( 3 )$$

The above describes time of flight mass analysers 10 having a predetermined convergence angle Θ of the mirror electrodes 12. However, mechanical imperfections may act to counter the time of flight correction effected by the correction electrodes 24. For example, the mechanical imperfections may be misalignment of the mirror electrodes 12 away from the predetermined convergence angle Θ and curvature in the mirror electrodes 12 such as sag. These imperfections directly impact resolving power.

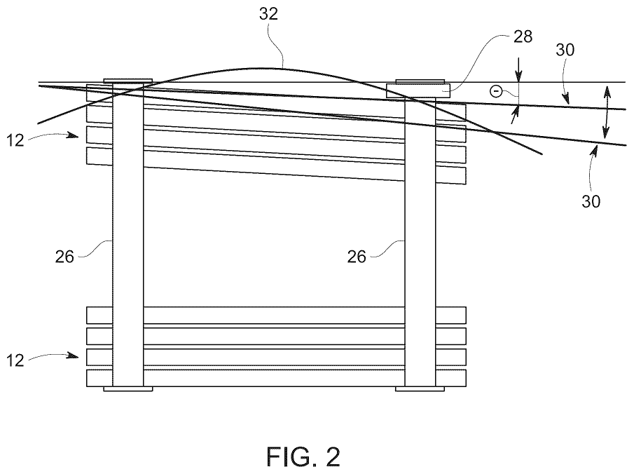

FIG. 2 shows a typical arrangement for holding the mirror electrodes 12 in place. Two parallel rods 26 hold the mirror electrodes 12, and the convergence angle Θ is defined by a shim 28 of a certain thickness placed between the end of one of the mirror electrodes 12 where it is held in place by one of the two parallel rods 26, thereby moving the mirror electrodes 12 out of parallel alignment. The rods 26 are fabricated of invar and have exactly equal lengths to keep the mirror electrodes' convergence angle Θ stable. FIG. 2 also shows potential mechanical imperfections, namely misalignment 30 and sag 32.

The mass analyser 10 is very sensitive to mechanical imperfections of the mirrors because the ion energy component of drift is typically only 1/1000 of the total kinetic energy (for example, the former is 5 eV per charge and the latter is 4000 eV per charge). The mirror tilt and the correction electrodes 24 generate, acting together, a drift reversing effective potential, which is only several volts strong. Any perturbation of the mirror shape affects this effective potential by coupling the oscillatory and the drift directions, and upsets the otherwise finely-balanced compensation of the ion-optical aberrations. Both spatial focusing of the drift and the and the ToF aberration compensation suffer.

One way of countering aberrations in the ToF is to impose extremely severe tolerances on the mass analyser 10, for example machining the components to an accuracy of less than 10 microns. However, for complex systems with typical dimensions of 0.5 m-3 m, such accuracy is near unachievable and/or prohibitively expensive and unsuited to volume production.

The existing correction electrodes 24 suffer from an inability to maintain resolution in the presence of such small mechanical misalignments of even 10 microns. This is because the tilt causes the ion beam's focal plane to shift from the ion detector 16 and to defocus. Adjusting the voltage of the stripe electrodes 24 to reposition the beam's focal plane brings them away from the voltage required for optimal resolution: the correction electrodes 24 have conflicting requirements to provide beam focus and to counter time-of-flight errors. Furthermore, existing correction electrodes 24 cannot properly provide drift focusing in the presence of curvature in the mirror electrodes 12. Additional correction electrodes with functions matching the mirror mechanical errors, as described in US2020/0243322 are capable of compensating the ToF aberrations but do not improve the spatial focusing of the ion's drift. Therefore, a mass analyser 10 having tilted mirror electrodes 12 will lose the ability to focus ions 20 onto the ion detector 16.

Instead of simple compensation of the ToF aberration in every Y-position of the drift axis (as per the correction electrodes of US2020/0243322), the ToF aberrations are better compensated in average on the full number of ion oscillations. These conditions are less precise, but still sufficient to maintain the high mass resolving power of the mass analyser 10. At the same time, the correction electrodes 24 should also restore the spatial focusing of ions 20 onto the ion detector 16.

The exact optimization of the shape function S(y) of the correction electrodes 24 is possible only for a specific shape of the mirror electrodes 12 and for a specific mirror electrodes' convergence angle Θ. In reality, the mirror electrodes 12 are straight with a precision of ±0.01 mm. The shim thickness has a similar accuracy, leading to residual loss of time of flight resolution.

If the mirror electrodes' convergence angle Θ is set wrongly or changes over time, adjustment of the mirror electrodes' convergence angle Θ requires disassembly and re-assembly of the mirror electrode unit. In principle, this is possible during manufacture but requires additional manufacturing and testing time. An accidental change of the mirror electrodes' convergence angle Θ during the mass analyser's use requires an arduous and time-consuming service. Such critical dependence on the mirror fabrication and positioning precision is a significant drawback of the mass analyser's design.

It has been realised that further refinement of the shape function S(y) of the correction electrodes 24 and the voltages applied to the correction electrodes 24 may be used to compensate for various mechanical deviations within a tilted mirror MR-ToF analyser 10. This allows adjustment of the ion flight time between the mirror electrodes 12, either overall or as a function of ion injection angle, and allows specific correction of errors in the mirror electrodes' tilt angle Θ or in the mirror electrode's curvature, acceptance of a wider range of ion injection angles, or even adjustment of the ion beam's focal plane position.

The solution to the problem of mechanical imperfections in the mirror electrodes 12 comprises adding a certain degree of flexibility in how the correction electrodes 24 are designed and operated. This allows correction of time-of-flight errors even when the mirror electrodes 12 are not exactly straight and when the mirror electrodes' convergence angle Θ deviates from the intended value. Advantageously, in operation, only small modifications around the vicinity of the voltages set on the correction electrodes 24 are required and no mechanical modifications are needed.

In a prior art mass analyser 10 like that of FIG. 1, there are two degrees of freedom available to assist in correcting time of flight errors due to mechanical imperfections. Namely, the correction electrodes 24 may be set to any voltage up to 100V and the initial angle of ion injection may be modified via application of a certain voltage on the ion deflector 18. However, this is insufficient to compensate for the adverse effects caused by mechanical imperfections in the mirror electrodes 12 because only two parameters cannot compensate for a continuum of all possible variations of the mirror electrodes' shapes.

It has been realised that mechanical imperfections require an arbitrary modification of the function s(y) which cannot be achieved solely by electrical means but requires a change of correction electrode 24 to another correction electrode 24 with a different shape. Accordingly, one or several additional correction electrodes 24 are introduced to supplement the existing (principal) correction electrode 24. Voltages may be set on the collection of correction electrodes 24, sometimes including holding one or more of the correction electrodes 24 at zero voltage bias, to correct for any mechanical imperfections. The correction electrodes 24 may be activated by applying non-zero biases uₙ, with n=1 . . . N. The resultant effective shape function of the combined correction electrodes is given by a linear superposition

$${S}^{*} ( y ) = S ( y ) + {\sum }_{n} \frac{{u}_{n}}{{U}_{s}} {S}_{n} ( y ) \qquad ( 4 )$$

where Sₙ(y) are the shape functions of the additional correction electrodes and Uₛ is the bias of the principal correction electrode 24.

Rather than trying to emulate any shape function S*(y), a finite number of parameters uₙ may be used to find shapes Sₙ(y) that compensate for the most common mechanical imperfections, namely misalignment of the mirror electrodes 12 (caused by, for example, imperfections in the thickness of the shim 28) and sag in the mirror electrodes 12 (i.e. any curvature of a mirror electrode 12 that is centered in the middle of the supporting rods 26). These are shown in FIG. 2 as an additional angular error 30 and a curvature 32 in one of the mirror electrodes 12. It should be noted that only a sum of curvatures of the two mirror electrodes 12 is effective for the ions' motion, so the correction of sags of both mirror electrodes 12 may be achieved with only one parameter.

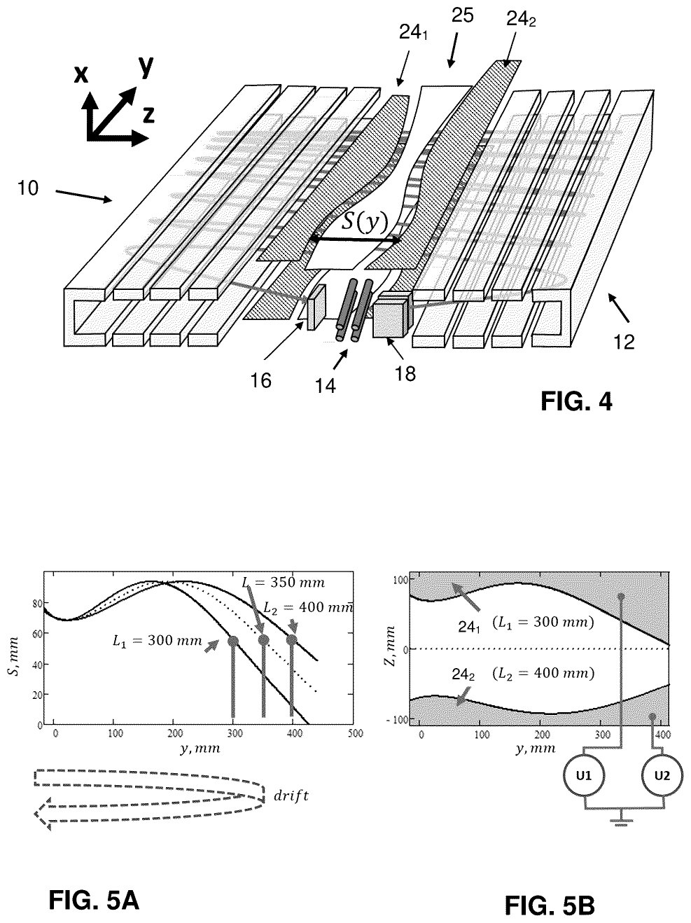

FIG. 4 shows a mass analyser 10 that may be used to correct an error in the mirror electrodes' convergence angle Θ, for example caused by an erroneous shim thickness. An imperfection in the mirror electrodes' convergence angle Θ doesn't drive the correction problem out of the class of optimal solutions for perfectly aligned mirror electrodes 12. If the optimal angle given by equation (3) above is Θ and the angle is set imperfectly as Θ*, a correction may be made by adjusting the mean drift length L of ions 20 through the mirror electrodes 12 accordingly, so that the imperfect angle Θ*will satisfy equation (3). The required mean drift length L*will be given by

$${L}^{*} = \frac{{Θ}^{*}}{Θ} L = \frac{{WK}_{0}^{2}}{1.245} {Θ}^{*}$$

There is normally a certain leeway to the mean drift length L*as the length is only restricted by the mirror electrodes' physical lengths and may be increased until the ions 20 come too close to the fringes in the mirror electrodes' electric fields. Hence, the maximum and minimum expected error away from the desired convergence angle Θ may be used to calculate required maximum and minimum values to mean drift length L*.

An alternative approach is to switch to another number of ion oscillations during the drift, i.e.

$${K}_{0}^{*} where {K}_{0}^{*} \neq {K}_{0}$$

$$and$$

$${K}_{0}^{*} = [ \sqrt{\frac{Θ}{{Θ}^{*}}} {K}_{0} ]$$

where the square brackets denote rounding to the nearest integer. In this way, the correction of the time of flight error may be achieved not at the designed number of oscillations K₀ before the ions 20 reach the ion detector 16 (e.g. 25 oscillations), but at a different number of oscillations (e.g. 24 or 26) to cover the anticipated range of convergence angles Θ*. Nevertheless, the number of oscillations must be an integer value and, therefore, a correction by adjusting the drift length L*may still be needed.

A technical difficulty in gauging the mean drift length L*is that the shape of the correction electrode 24 given by the dimensionless function s(y) is normalised to a specific (nominal) drift length L. However, a correction electrode 24 with a nominal drift length L may be (in a certain interval of L) emulated by electrically biasing two correction electrodes 24 having differing drift lengths with individual voltages.

FIG. 4 illustrates a mass analyser 10 comprising two pairs of correction electrodes 24. A space 25 separates adjacent correction electrodes 24, which is effectively grounded. In this case, the intended mirror electrodes' convergence angle Θ=0.05° and the nominal mean drift length is 350 mm. However, it is anticipated that the electrodes' convergence angle Θ may differ by ±15%. To accommodate this, the pair of principal correction electrodes 24 is effectively split into two corresponding pairs of correction electrodes 24₁ and 24₂ and further adapted to provide the minimum and maximum mean drift lengths L*arising from the anticipated ±15% variation in the intended mirror electrodes' convergence angle Θ.

FIG. 4 shows a shortened pair of additional correction electrodes 24₁ designed for a mean drift length of 300 mm, and a lengthened pair of additional correction electrodes 24₂ designed for a mean drift length of 400 mm. It should be noted that the physical lengths of the correction electrodes 24₁ and 24₂ is greater than the mean drift lengths L*to ensure ions 20 do not experience fringe fields arising near the ends of the correction electrodes 24₁ and 24₂. Applying a voltage to the shortened correction electrodes 24₁ and not the lengthened correction electrodes 24₂ would set the mean drift length L*=300 mm and so correct for an actual convergence angle of Θ*=0.05°×300/350=0.04285°. Applying a voltage to the lengthened correction electrodes 24₂ and not the shortened correction electrodes 24₁ would set the mean drift length L*=400 mm and so correct for an actual convergence angle of Θ*=0.05°×400/350=0.05714°. Hence, time of flight corrections are achieved even for the mirror electrodes 12 with imperfections in the convergence angle Θ of ±15%.

In addition, providing two pairs of correction electrodes 24₁, 24₂ with different mean drift lengths L₁ and L₂ means that any effective drift length L*between the values of L₁ and L₂ may be achieved by placing suitable voltages on both pairs of correction electrodes 24₁, 24₂. As both correction electrodes 24₁, 24₂ now contribute to the correction otherwise provided by a single principal correction electrode 24, each correction electrode 24₁, 24₂ is provided with a fixed voltage of ½ Uₒ plus or minus an adjustment Δu to correct for mechanical imperfections. The two contributions of ½ Uₒ sum to provide the required correction for tilt, whereas adding the correcting offset Δu to one of the correction electrodes 24₁, 24₂ and subtracting it from the other of the correction electrodes 24₁, 24₂ means that the effective mean drift length L_{eff} of one correction electrode dominates over the other, thereby moving the effective mean drift length L_{eff} away from the nominal value L*.

Hence, the correction electrodes 24₁, 24₂ may be biased with different voltages U₁=½U₀+Δu and U₂=½U₀−Δu. The effective mean drift length L_{eff} is given by the supposition

$${L}_{eff} ( Δ u ) = ( \frac{1}{2} + \frac{Δ u}{2 {U}_{0}} ) {L}_{1} + ( \frac{1}{2} - \frac{Δ u}{2 {U}_{0}} ) {L}_{2}$$

As expected, when Δu=U₀ only the shortened correction electrode 24₁ is energised and the effective drift length L_{eff}=L₁, and when Δu=−U₀ only the lengthened correction electrode 24₂ is energised and the effective drift length L_{eff}=L₂. However, if both the shortened and lengthened electrodes 24₁ and 24₂ are biased with the same voltage U₁=U₂=U₀ (i.e. Δu=0), then the effective drift length L_{eff}=½×(L₁+L₂), i.e. the average of the mean drift lengths which is the nominal drift length L*required for mirror electrodes 12 without any mechanical imperfections. Adjusting the value of Δu to finite values between U₁=U₂ allows any mean drift length between 0 mm and 40 mm to be set.

As just explained, a correction electrode 24 with an effective drift length L_{eff} may be emulated by electrically biasing two correction electrodes 24₁ and 24₂ having differing mean drift lengths L₁ and L₂ with different voltages. Also, it was noted that the physical lengths of the correction electrodes 24₁ and 24₂ is greater than the mean drift lengths L*to ensure ions 20 do not experience fringe fields arising near the ends of the correction electrodes 24₁ and 24₂. Hence, although FIG. 4 shows additional correction electrodes 24₁ and 24₂ having different physical lengths L₁ and L₂, this need not be the case. The additional correction electrodes 24₁ and 24₂ may have the same physical length provided that their shape functions S(y) produce different mean drift lengths L₁ and L₂.

FIG. 5A shows such an example where additional correction electrodes 24₁ and 24₂ of the same physical length have different mean drift lengths of L₁=300 and L₂=400 mm. FIG. 5B shows the resulting correction electrodes 24₁, 24₂ with the same physical length but differing drift lengths L₁, L₂ placed on either side of the central axis Z=0. A variable power supply provides the required voltages U₁=½U₀+Δu and U₂=½U₀−Δu.

In the above embodiment, a pair of correction electrodes 24₁, 24₂ are used that correct for time of flight dispersion arising from the tilted mirror electrodes 12, and also for mechanical imperfections (i.e. the correction electrodes 24₁, 24₂ fulfil the role of principal correction electrodes and additional correction electrodes). In alternative embodiments, two pairs of principal correction electrodes 24 are used to correct for the time of flight dispersion arising from the tilted mirror electrodes 12, and a pair of additional correction electrodes 24₃ are added to correct for mechanical imperfections. The pair of additional correction electrodes 24₃ have an edge with a shape given by the difference between a shortened correction electrode 24₁ with a drift length L₁=L₀+ΔL and a lengthened electrode 24₂ with a drift length L₂=L₀−ΔL, such that

$${S}_{1} ( y ) = {c}_{1} + {k}_{1} \times [ s ( \frac{y}{{L}_{2}} ) - s ( \frac{y}{{L}_{1}} ) ]$$

where, as before, the multiplicative constant k₁ is arbitrary and the additive constant c₁ may be arbitrarily chosen so that S₁(y)>0 (i.e. the width is positive) along the whole length of the correction electrode 24₃. As before, the mean drift lengths of the shortened and lengthened correction electrodes 24₁, 24₂ may be calculated based on the anticipated error range in the convergence angle Θ.

The effective drift length L_{eff} is given by the formula

$${L}_{eff} ( {u}_{1} ) ≅ {L}_{0} + \frac{{u}_{1} {k}_{1}}{{U}_{0} {k}_{0}} Δ L$$

The voltage u₁ applied to the “differential” correction strip 24₃ may be set to zero where the mirror electrodes 12 have the exact desired convergence angle Θ with no mechanical imperfection in their alignment. In this case, the effective drift length L_{eff} becomes just the nominal drift length L₀. In the case of a positive error in the mirror electrodes' convergence angle Θ, the effective drift length L_{eff} should be increased proportionally, in which case a positive voltage is applied to the differential correction electrode 24₃ to make L_{eff}>L₀. In the case of a negative error in the mirror electrodes' convergence angle Θ, a negative voltage is applied to the differential correction electrode 24₃ to make L_{eff}<L₀.

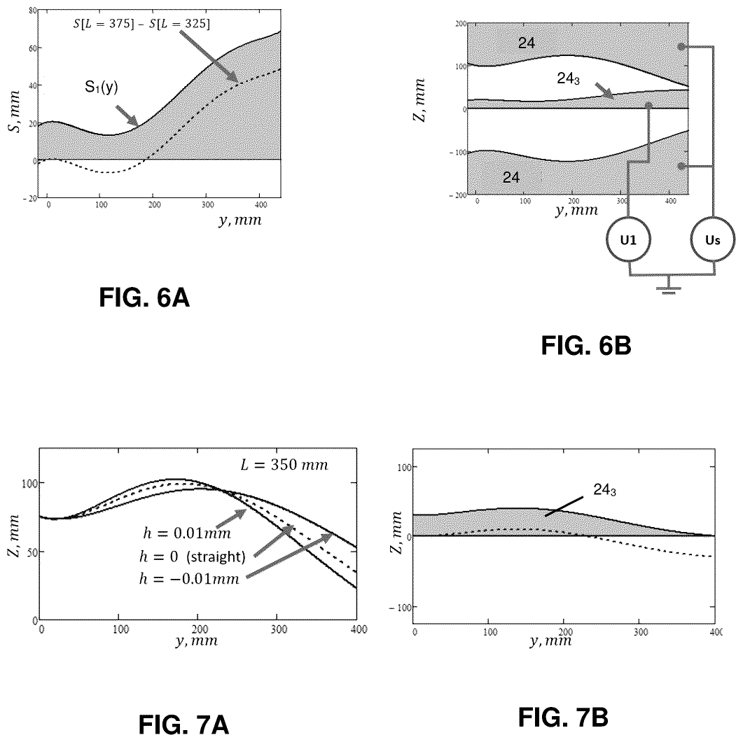

FIG. 6A shows the shape function S(y) of such a differential correction electrode 24₃, while FIG. 6B shows such a differential correction electrode 24₃ in place between two principal correction electrodes 24 that operate to correct the mirror electrodes' tilt. The principal correction electrodes 24 have the nominal effective drift length L₀ and a voltage of a particular value and polarity is placed on the differential correction electrode 24₃ when a different effective drift length L_{eff} is required to correct for mechanical imperfections. The voltage placed on the principal correction electrodes 24 Uₛ=½U₀ to ensure that the principal correction electrodes 24 combine to provide the required correction of the tilt angle Θ. The advantage of the correction electrode arrangement of FIG. 6B over that of FIG. 5B is that it maintains symmetry around the y axis whatever correction voltage u₁ is applied to the differential correction electrode 24₃.

In addition to compensating for mechanical imperfections in the convergence angle Θ of the mirror electrodes 12, correction electrodes 24 may be used to correct any curvature in the mirror electrodes 12. The most common mechanical imperfection in the mirror electrodes' shape is a sag between the supporting rods 26 which may be approximated by a sag parameter h and the quadratic function of the mirror electrode's shape is given by:

$$4 h \frac{( y - {Y}_{1} ) ( {Y}_{2} - y )}{{( {Y}_{2} - {Y}_{1} )}^{2}}$$

where Y₁ and Y₂ are the positions of the supporting rods 26.

FIG. 7A shows the shape functions optimized for a predicted error range h=±0.01 mm in comparison with the optimal shape function for perfectly straight mirror electrodes 12 (i.e. h=0). Where a differential correction electrode 24₃ is to be used, the difference between the shape functions for the determined maximum error values of h (h=+0.01 mm and h=−0.01 mm) defines the shape function of the differential correction electrode 24₃, as shown in FIG. 7B. In operation, the differential correction electrode 24₃ is biased with a voltage uₛ ∈[−0.5Uₛ, 0.5Uₛ]. If the actual mirror electrodes' curvature reaches h=0.01 mm, the differential correction electrode 24₃ should be biased with a voltage equal to 0.5 Uₛ thus emulating the shape optimized for the actual curvature of the mirror electrodes 12. In the opposite case of maximal anticipated negative sag h=−0.01 mm, the differential correction electrode 24₃ is biased with a voltage of −0.5 Uₛ to compensate for the mechanical imperfection.

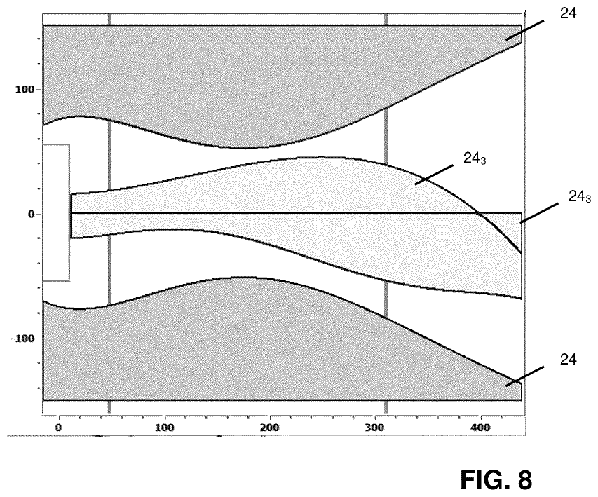

FIG. 8 shows a further embodiment that includes a pair of principal correction electrodes 24 that correct for mechanical imperfections in the convergence angle Θ of the mirror electrodes 12, as well as further differential correction electrodes 24₃ that correct for mechanical imperfections. Separate pairs of differential correction electrodes 24₃ correct for error in tilt and curvature independently.

Although the embodiments described above are primarily intended to correct for mechanical errors in tilt and curvature, they may also provide at least partial correct for other mechanical imperfections giving rise to time of flight aberrations. That is, the voltages applied to the correction electrodes 24 may be tuned to provide optimal resolution, and this will inherently account for other imperfections.

A person skilled in the art will appreciate that the above embodiments may be varied in many different respects without departing from the scope of the present invention that is defined by the appended claims.

For example, while errors in the convergence angle Θ of the mirror electrodes 12 is explained by reference to an example in which a shim 28 is used to cause the convergence, other arrangements are possible. The convergence angle Θ could be cut into a mirror electrode 12 or set by the size of the mounting, such as by setting the length of the mounting rods 26 or positioning of mounting points in a supporting frame. The mirror could have an angle built into its construction by varying the thickness of the electrodes or their separators (our mirrors are built as a stack of aluminium electrodes and ceramic spacers).

While curvature in the mirror electrodes 12 amounting to sag has been described, this sag is not necessarily caused by gravity. The curvature may be any distortion that follows a curve that peaks at the middle of the mirror electrode 12. This may arise from release of stress in metal mirror electrodes 12, which causes the mirror electrodes 12 to distort during and after machining. Other factors such as thermal shifts and assembly errors/insufficient force can also cause sag.

We claim:

1. A multi-reflection time of flight mass spectrometer comprising:
two ion-optical mirrors, each mirror elongated generally along a drift direction away from an ion injection point (a Y direction), each mirror opposing the other in a Z direction, the Z direction being orthogonal to the Y direction, and wherein the two mirrors are tilted at a tilt angle such that a separation between the mirrors in the Z direction decreases as a distance along the Y direction increases; and
at least two correction electrodes extending along at least a portion of the Y direction in or adjacent the space between the mirrors; and
wherein:
each correction electrode has a surface substantially parallel to the Y-Z plane and has a shape such that the surface is separated from one of the mirrors by a distance that varies along the Y direction and in which the correction electrodes are, in use, electrically biased with voltages so as to produce, in at least a portion of the space extending between the opposing mirrors, a combined voltage offset which varies as a function of the distance along the Y direction, wherein the voltages include a first component to correct for an intended aberration arising from an intended tilt angle of the mirrors and a second component to correct for unintended aberrations arising from a range of perturbations to an ideal time of flight extending from a maximum perturbation to a minimum perturbation, wherein the second component varies between a maximum value and a minimum value; and
the shapes of the at least two correction electrodes are such that some or all the at least two correction electrodes may be energised with the voltages including the first component and the second component, that varies between a maximum value and a minimum value, to generate a range of combined voltage offsets that compensate for a range of time of flight aberrations corresponding to the intended aberration arising from the intended tilt angle of the mirrors and the unintended aberrations arising from the range of perturbations to the ideal time of flight extending from the maximum perturbation to the minimum perturbation.

2. The multi-reflection time of flight mass spectrometer of claim 1, wherein the range of perturbations to the ideal time of flight extends from a maximum perturbation due to a maximum positive misalignment error in the mirrors to a minimum perturbation due to a maximum negative misalignment error in the mirrors.

3. The multi-reflection time of flight mass spectrometer of claim 2, wherein the combined voltage offset acts to shorten or lengthen an average drift length of the ions through the mirrors in the +Y direction before they are reflected and drift back through the mirrors in the −Y direction.

4. The multi-reflection time of flight mass spectrometer of claim 2, wherein the combined voltage offset acts to increase or decrease a number of oscillations the ions make as they drift through the mirrors.

5. The multi-reflection time of flight mass spectrometer of claim 1, wherein the range of perturbations to the ideal time of flight extends from a maximum perturbation due to a maximum positive curvature error in the mirrors to a minimum perturbation due to a maximum negative curvature error in the mirrors.

6. The multi-reflection time of flight mass spectrometer of claim 5, wherein the maximum positive and negative curvature errors in the mirrors correspond to curvature in the mirrors due to sag.

7. The multi-reflection time of flight mass spectrometer of claim 5, wherein the shape of an electrode of the at least two correction electrodes compensates for misalignment errors independently of curvature errors, and the shape of another electrode of the at least two correction electrodes compensates for curvature errors independently of misalignment errors.

8. The multi-reflection time of flight mass spectrometer of claim 1, wherein the at least two correction electrodes comprise one or more pairs of correction electrodes; and
each pair of the one or more pairs of correction electrodes comprises:
a first correction electrode shaped such that when the first correction electrode is energised with a voltage having a value equal to the first component plus the maximum value of the second component, the first correction electrode generates a voltage offset that compensates for the intended aberration arising from the intended tilt angle of the mirrors and the unintended aberration arising from the maximum perturbation, and
a second correction electrode shaped such that when the second correction electrode is energised with a voltage having a value equal to the first component plus the minimum value of the second component, the second electrode generates a voltage offset that compensates for the intended aberration arising from the intended tilt angle of the mirrors and the unintended aberration arising from for the minimum perturbation.

9. The multi-reflection time of flight mass spectrometer of claim 8, wherein the first and second correction electrodes are shaped such that they produce different average drift lengths of ions through the mirrors and-wherein a physical length of the first and second correction electrodes in the Y direction differ.

10. The multi-reflection time of flight mass spectrometer of claim 1, wherein the at least two correction electrodes comprise:
at least a first correction electrode having a shape to compensate for an intended time of flight aberration arising from the intended tilt angle of the mirrors when energised with a voltage equal to the first component; and
a second correction electrode having a shape corresponding to a difference between the shapes required such that, when energised with a voltage having a value equal to the maximum value of the second component, the second correction electrode generates a voltage offset that compensates for the maximum perturbation and, when energised with a voltage having a value equal to the minimum value of the second component, the second correction electrode generates a voltage offset that compensates for the minimum perturbation.

11. A method of operating a multi-reflection time of flight mass spectrometer comprising:
two ion-optical mirrors, each mirror elongated generally along a drift direction away from an ion injection point (a Y direction), each mirror opposing the other in a Z direction, the Z direction being orthogonal to the Y direction, and wherein the two mirrors are tilted such that a separation between the mirrors in the Z direction decreases as a distance along the Y direction increases; and
at least two correction electrodes extending along at least a portion of the Y direction in or adjacent the space between the mirrors; and
wherein:
each correction electrode has a surface substantially parallel to the Y-Z plane and has a shape such that the surface is separated from one of the mirrors by a distance that varies along the Y direction and in which the correction electrodes are, in use, electrically biased with voltages so as to produce, in at least a portion of the space extending between the opposing mirrors, a combined voltage offset which varies as a function of the distance along the Y direction, wherein the voltages include a first component to correct for an intended aberration arising from the an intended tilt angle of the mirrors and a second component to correct for unintended aberrations arising from a range of perturbations to an ideal time of flight extending from a maximum perturbation to a minimum perturbation, wherein the second component varies between a maximum value and a minimum value; and
the shapes of the at least two correction electrodes are such that some or all the at least two correction electrodes may be energised with the voltages including the first component and the second component, that varies between a maximum value and a minimum value, to generate a range of combined voltage offsets that compensate for a range of time of flight aberrations corresponding to the intended aberration arising from the intended tilt angle of the mirrors and the unintended aberrations arising from the range of perturbations to the ideal time of flight extending from the maximum perturbation to the minimum perturbation; wherein
the method comprises:
energising the mirrors to provide electric fields to cause ions to follow a zig zag path through the mirrors;
energising each of the at least two correction electrodes with a voltage including the first component and/or the second component such that the at least two correction electrodes generate a combined voltage offset that compensates for the intended aberration and the aberrations;
injecting ions from an ion source into the mirrors; and
detecting the ions with an ion detector located at the same end of the mirrors as the ion source.

12. The method of claim 11, wherein the at least two correction electrodes comprise one or more pairs of correction electrodes; and
each pair of the one or more pairs of correction electrodes comprises:
a first correction electrode shaped such that when the first correction electrode is energised with a voltage having a value that equals the first component plus the maximum value of the second component, the first correction electrode generates a voltage offset that compensates for the intended aberration and the unintended aberration arising from the maximum perturbation, and
a second correction electrode shaped such that when the second correction electrode is energised with a voltage having a value equal to the first component plus the minimum value of the second component, the second correction electrode generates a voltage offset that compensates for the intended aberration and the unintended aberration arising from the minimum perturbation; and
the method comprises:
(i) compensating for the maximum perturbation by energising the first correction electrode with a voltage having the value equal to the first component and the maximum value of the second value, and not energising the second correction electrode;
(ii) compensating for the minimum perturbation by energising the second correction electrode with a voltage having the value equal to the first component and the minimum value of the second component, and not energising the first correction electrode; or
(iii) compensating for a perturbation between the maximum and minimum perturbations by energising the first correction electrode with a voltage with a value equal to a half of a first contribution plus a second contribution with a value between the maximum and minimum values, and energising the second correction electrode with a voltage with a value equal to a half of the first component plus the second component with the value between the maximum and minimum values.

13. The method of claim 11, wherein the at least two correction electrodes comprise:
at least a first correction electrode having a shape to compensate for time of flight aberration arising from the intended tilt angle of the mirrors when energised with a voltage equal to the first component; and
a second correction electrode having a shape corresponding to a difference between the shapes required such that, when energised with a voltage having the maximum value of the second component, the second correction electrode generates a voltage offset that compensates for the maximum perturbation and, when energised with a voltage having the minimum value of the second component, the second correction electrode generates a voltage offset that compensates for the minimum perturbation; and
the method comprises:
(i) compensating for the maximum perturbation by energising the at least a first correction electrode with a voltage equal to the first component to compensate for the intended aberration and energising the second electrode with a voltage having the maximum value of the second component to compensate for the unintended aberrations;
(ii) compensating for the minimum perturbation by energising the at least a first correction electrode with a voltage equal to a first contribution to compensate for the intended aberration and energising the second electrode with a voltage having the minimum value of the second component to compensate for an unintended time of flight aberrations; or
(iii) compensating for a perturbation between the maximum and minimum perturbations by energising the at least a first correction electrode with a voltage equal to the first component to compensate for the intended aberration and energising the second electrode with a voltage with a value equal to the second component having a value between the maximum and minimum values to compensate for the unintended time of flight aberrations.

14. A method of designing a multi-reflection time of flight mass spectrometer, comprising:
configuring an ideal arrangement of an ion source, an ion detector and two ion-optical mirrors, each mirror elongated generally along a drift direction away from an ion injection point (a Y direction), each mirror opposing the other in a Z direction, the Z direction being orthogonal to Y, such that ions provided from the ion source enter mirrors at the ion injection point and then follow a zig zag path through the mirrors when the mirrors are energised to provide electric fields;
configuring at least two correction electrodes extending along at least a portion of the Y direction in or adjacent a space between the mirrors, wherein each correction electrode has a surface substantially parallel to the Y-Z plane and has a shape such that the surface is separated from one of the mirrors by a distance that varies along the Y direction and in which the correction electrodes are, in use, electrically biased with voltages so as to produce, in at least a portion of the space extending between the opposing mirrors, a combined voltage offset which varies as a function of the distance along the Y direction, wherein the voltages include a first component to correct for an intended aberration arising from an intended tilt angle of the mirrors and a second component to correct for unintended aberrations arising from a range of perturbations to an ideal time of flight extending from a maximum perturbation to a minimum perturbation, wherein the second component varies between a maximum value and a minimum value:
determining maximum and minimum perturbations away from the ideal arrangement of the mirrors, and the resulting maximum and minimum aberrations in time of flight of ions through the mirrors; and
determining the shape of the at least two correction electrodes such that some or all the at least two correction electrodes can be energised with voltages including the first component and the second component, that varies between a maximum value and a minimum value, to generate a range of combined voltage offsets that compensate for a range of time of flight aberrations corresponding to the intended aberration arising from the intended tilt angle of the mirrors and the unintended aberrations arising from the range of perturbations to the ideal time of flight extending from the maximum perturbation to the minimum perturbation.

15. The method of claim 14, comprising determining the shapes of the at least two correction electrodes to compensate for a range of time of flight aberrations corresponding to a range of perturbations to the ideal time of flight extending from a maximum perturbation due to a maximum positive misalignment error in the mirrors to a minimum perturbation due to a maximum negative misalignment error in the mirrors, wherein the combined voltage offset acts to shorten or lengthen an average drift length of the ions through the mirrors in the +Y direction before they are reflected and drift back through the mirrors in the −Y direction.

16. The method of flight mass spectrometer of claim 15, wherein the combined voltage offset acts to increase or decrease a number of oscillations the ions make as they drift through the mirrors.

17. The method of claim 14, comprising determining the shapes of the at least two correction electrodes to compensate for a range of time of flight aberrations corresponding to a range of perturbations to the ideal time of flight extending from a maximum perturbation due to a maximum positive curvature error in the mirrors to a minimum perturbation due to a maximum negative curvature error in the mirrors.

18. The method of claim 17, wherein the maximum positive and negative curvature errors in the mirrors correspond to curvature in the mirrors due to sag.

19. The method of claim 17, further comprising determining the shape of an electrode of the at least two correction electrodes to compensate for misalignment errors independently of curvature errors, and the shape of another electrode of the at least two correction electrodes to compensate for curvature errors independently of misalignment errors.

20. The method of claim 14, wherein the at least two correction electrodes comprise one or more pairs of correction electrodes; and
the method comprises for the or each pair of correction electrodes:
determining the shape of a first correction electrode such that when the first correction electrode is energised with a voltage equal to the first component plus the maximum value of the second component, the first correction electrode generates a voltage offset that compensates for the intended aberration arising from an intended tilt angle of the mirrors and the unintended aberration arising from the maximum perturbation, and
determining the shape of a second correction electrode such that when the second correction electrode is energised with a voltage equal to the first component plus the minimum value of the second component, the second electrode generates a voltage offset that compensates for the intended aberration arising from of the intended tilt angle of the mirrors and the unintended aberration arising from for the minimum perturbation.

21. The method of claim 20, wherein the first and second correction electrodes are shaped such that they produce different average drift lengths of ions through the mirrors and, optionally, wherein a physical length of the first and second correction electrodes in the Y direction differ.

22. The method of claim 14, comprising determining the shape of at least a first correction electrode that, when energised with a voltage having a value equal to the first component, compensates for time of flight aberrations corresponding to the intended tilt angle of the mirrors along the Y direction; and
determining the shape of a second correction electrode to correspond to a difference between the shapes required such that, when energised with a voltage having the maximum value of the second component, the second correction electrode generates a voltage offset that compensates for the maximum perturbation and, when energised with a voltage having the minimum value of the second electrode, the second correction electrode generates a voltage offset that compensates for the minimum perturbation.
